(19) United States
(12) Patent Application Publication
(10) Pub. No.: US 2011/0310068 A1
(43) Pub. Date: Dec. 22, 2011

(54) DISPLAY DEVICE

(75) Inventors: Masaki Nose, Kawasaki (JP); Hirokata Uehara, Kawasaki (JP); Tomohisa Shingai, Kawasaki (JP)

(73) Assignee: FUJITSU LIMITED, Kawasaki (JP)

(21) Appl. No.: 13/032,971

(22) Filed: Feb. 23, 2011

(30) Foreign Application Priority Data
Jun. 16, 2010 (JP) 2010-137541

(51) Int. Cl. G09G 5/00

(52) U.S. Cl. 345/204

(57) ABSTRACT

A display device includes a display part, an electrode that applies a pulse to a pixel of the display part, and a control part that controls the application of the pulse, the control part controls the position of the electrode that applies the pulse so as to change at irregular intervals. The control part selects the position of the electrode that applies the pulse alternately from the center toward both ends and densely at the center and sparsely at both ends, or alternately from both ends toward the center and densely at both ends and sparsely at the center and thus selects all the electrodes.

### CROSS-REFERENCE TO RELATED APPLICATIONS

This application is based upon and claims the benefit of priority of the prior Japanese Patent Application No. 2010-137541, filed on Jun. 16, 2010, the entire contents of which are incorporated herein by reference.

### FIELD

The embodiments discussed herein are related to a display device.

### BACKGROUND

As a display device, a display device using liquid crystal, such as electronic paper, is being developed. As a method of driving a display device that uses liquid crystal, for example, the dynamic drive scheme (DDS) is used. By using DDS, it is possible to rewrite a high-contrast image at high speed.

The drive period of DDS is roughly divided into three stages, i.e., it includes a preparation stage, a selection stage, and an evolution stage in this order from the beginning. Before and after the preparation stage, the selection stage, and the evolution stage, a non-select stage is provided. The preparation stage is a stage during which liquid crystal is initialized into a homeotropic state and during the preparation stage, a plurality of preparation pulses of a comparatively high voltage is applied. The selection stage is a stage during which branching into a planar state (bright state: white display) or a focal conic state (dark state: black display) as the final state is triggered. During the selection stage, the homeotropic state is formed almost completely when the state is finally switched to the planar state or a transient planar state is formed almost completely when the state is switched to the focal conic state. During the selection stage, a pulse of a relatively high voltage is applied when the state is switched to the planar state and a pulse of a relatively low voltage is applied when switched to the focal conic state. During the evolution stage, following the change to the transient state during the immediately previous selection stage, the planar state or the focal conic state is settled. During the evolution stage, a plurality of evolution pulses of a voltage between the voltage of the preparation pulse and that of the selection pulse is applied.

In a display device using liquid crystal, scan electrodes are driven by, for example, a general-purpose scan driver (common driver) and data electrodes are driven by a segment driver (data driver), respectively. In driving by DDS, scan electrodes and data electrodes are used.

In DDS, pulse data specifying a pulse group of a plurality of preparation pulses, one selection pulse, and a plurality of evolution pulses is input sequentially to a scan driver and the pulse data is shifted sequentially by a shift register of the scan driver. Due to this, the position of the scan electrode to which the above-mentioned pulse group is applied shifts one by one from one end toward the other end. The scan driver outputs data that specifies a non-select pulse at the time of reset. Further, after the above-mentioned pulse group, data that specifies a non-select pulse is input to the scan driver, and therefore, there are non-select pulses before and after the pulse group. The segment driver outputs display data (white or black) corresponding to one line (scan line) in accordance with a scan electrode to which the selection pulse is applied.

A display device using liquid crystal is driven not only by DDS but also by a drive method in which an auxiliary pulse (the above-mentioned preparation pulse and evolution pulse) is added to a rewrite pulse (the above-mentioned selection pulse) and the rewrite speed and contrast are improved by the auxiliary pulse.

As described above, for a method of driving cholesteric liquid crystal, making an attempt to improve the rewrite speed and contrast by adding an auxiliary pulse is frequently carried out. However, at the time of rewrite, the auxiliary pulse appears like a thick black belt, and therefore, the display content becomes hard to recognize and the fine view during drawing is lost because the thick black belt obstructs the view. Further, the scan electrode is scanned for each line, and therefore, it takes time to recognize the display content.

Because of the above, it has been proposed to enable quick recognition of a display content as well as dispersing and making inconspicuous the black belt during the preparation/evolution stages that occurs during drawing by interlacing in which a scan is performed twice for every two lines when rewriting a display.

### Related Documents

[Patent Document 1] Japanese Laid-open Patent Publication No. 2001-242437
[Patent Document 2] Japanese Laid-open Patent Publication No. 2001-282192
[Patent Document 3] Japanese Laid-open Patent Publication No. 2001-282202
[Patent Document 4] Japanese Laid-open Patent Publication No. 2001-282203
[Patent Document 5] Japanese Laid-open Patent Publication No. 2001-282204
[Patent Document 6] Japanese Laid-open Patent Publication No. 2002-148585
[Patent Document 7] Japanese Laid-open Patent Publication No. 2008-033338

### SUMMARY

According to a first aspect of the embodiments, a display device includes a display part, an electrode that applies a pulse to a pixel of the display part, and a control part that controls the application of the pulse, the control part controls the position of the electrode that applies the pulse so as to change at irregular intervals.

According to another aspect, a display device includes a plurality of laminated display elements, the display element includes a display part, an electrode that applies a pulse to a pixel of the display part, and a control part that controls the application of the pulse, and the control part controls the position of the electrode that applies the pulse so as to change at irregular intervals and at the same time, controlling the changes in the position of the plurality of scan electrodes that apply the pulse differ at least between two of the plurality of display elements.

The object and advantages of the embodiments will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a configuration of a display device in a first embodiment;

FIG. 2 is a diagram illustrating a configuration of a display element used in the first embodiment;

FIG. 3 is a diagram illustrating a configuration of one panel;

FIGS. 4A and 4B are diagrams explaining a state of cholesteric liquid crystal;

FIG. 5 illustrates an example of voltage-reflection characteristics of general cholesteric liquid crystal;

FIG. 6 is a diagram illustrating a drive waveform in the dynamic drive scheme (DSS);

FIG. 7 illustrates drive waveforms a scan driver outputs during a preparation stage, a selection stage, an evolution stage, and a non-select stage, driver waveforms a segment driver outputs for a white display and a black display, and waveforms applied to liquid crystal in the first embodiment;

FIG. 8 is a diagram more specifically illustrating a voltage waveform applied to liquid crystal molecules when the scan driver and the segment driver output the drive waveforms illustrated in FIG. 7;

FIG. 9 is a diagram illustrating a scan order in the display device in the first embodiment;

FIG. 10 is a diagram for schematically explaining the scan order illustrated in FIG. 9;

FIG. 11 is a diagram illustrating a configuration of a scan driver;

FIG. 12 is a diagram explaining the operation of the scan driver, a diagram illustrating the scan order and a change of line selection data;

FIG. 13 is a time chart illustrating transfer of line selection data to the scan driver and transfer of image data to the segment driver at scan number 0;

FIG. 14 is a diagram explaining the change in the scan position (scan order) in the first embodiment from another aspect;

FIG. 15 is a diagram explaining a modified example of the scan order;

FIG. 16 is a diagram explaining another modified example of the scan order;

FIG. 17 is a diagram explaining still another modified example of the scan order;

FIG. 18 is a diagram illustrating a configuration of a control circuit when determining the scan order in FIG. 17;

FIG. 19 is a flow chart illustrating processing in a line information amount calculation part and a scan order determination part;

FIG. 20 is a diagram illustrating a configuration of a modified example that has enabled the change of the scan order;

FIG. 21 is a diagram illustrating a further modified example of the modified example that has enabled the change of the scan order in FIG. 20;

FIG. 22 is a diagram illustrating a scan order in a display device in a second embodiment;

FIG. 23 is a diagram illustrating a voltage waveform applied to liquid crystal molecules of one scan line in a display device in a third embodiment; and

FIGS. 24A and 24B are diagrams illustrating outputs of a scan driver and a segment driver configured by two-value output general-purpose driver IC and voltages applied to each pixel when a pseudo reset method is performed.

### EMBODIMENTS

Embodiments are explained below specifically with reference to the drawings.

### First Embodiment

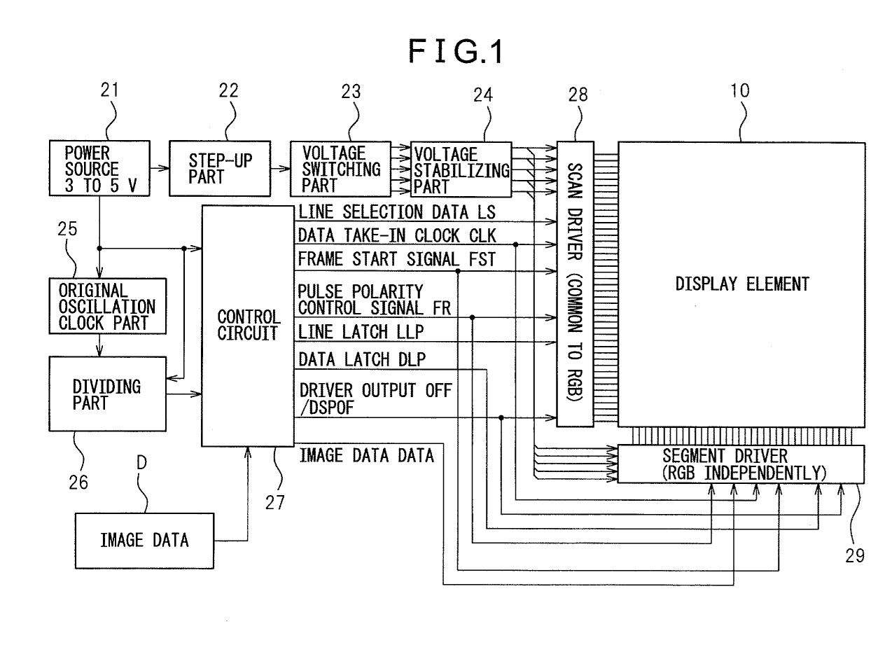

A first embodiment is explained with reference to FIG. 1 to FIG. 14.

FIG. 1 is a block diagram illustrating a display device in the first embodiment.

The display device in the first embodiment includes a display element 10, a power source 21, a step-up part 22, a voltage switching part 23, a voltage stabilizing part 24, an original oscillation clock part 25, a dividing part 26, a control circuit 27, a scan driver 28, and a segment driver 29.

The power source 21 outputs a voltage of, for example, 3 V to 5 V. The step-up part 22 steps up a voltage input from the power source 21 to +36 V to +40 V by a regulator, such as a DC-DC converter. The voltage switching part 23 generates various voltages by dividing a voltage using a resistor etc. The voltage stabilizing part 24 uses a voltage follower circuit of an operational amplifier to stabilize various voltages supplied from the voltage switching part 23.

The original oscillation clock part 25 generates a base clock that serves as the base of operation. The dividing part 26 divides the base clock and generates various clocks necessary for the operation, to be described later.

The display element 10 is, for example, a display element in which three cholesteric liquid crystal panels of RGB are laminated and which is capable of producing a color display. This display element is in conformity with, for example, the A4 size XGA specifications and has 1,024×768 pixels. Here, 1,024 data electrodes and 768 scan electrodes are provided and the segment driver 29 drives the 1,024 data electrodes and the scan driver 28 drives the 768 scan electrodes. Because image data given to each pixel of RGB is different, the segment driver 29 drives each data electrode independently. The scan driver 28 commonly drives the scan electrodes of RGB. The scan line corresponding to the scan electrode at the uppermost part of the screen is assumed to be the 0th line and the scan line corresponding to the scan electrode at the lowermost part of the screen is assumed to be the 767th line.

There is manufactured a general-purpose STN driver as a product, which may be used both as a scan driver (common driver) and as a segment driver by setting the operation mode. In the first embodiment, the scan driver 28 and the segment driver 29 are realized by the general-purpose STN driver. The segment driver 29 is set to the segment mode and performs the normal operation. The scan driver 28 is usually set to the common mode, however, in the first embodiment, it is set to a mode in which the scan driver 28 operates as a segment driver. In the first embodiment, the general-purpose STN driver is set to a mode in which it operates as a segment driver and then used as a scan driver, and therefore, part of the power source voltage supplied to the segment driver 29 is replaced and supplied to the scan driver 28 as a power source voltage.

The control circuit 27 generates control signals based on the base clock, various clocks, and image data D and supplies them to the scan driver 28 and the segment driver 29. Line selection data LS is data to specify a scan line to which the scan driver 28 applies the preparation pulse, the selection pulse, and the evolution pulse and a 2-bit signal here. Image data DATA is data to specify the voltage the segment driver 29 applies to each data electrode to be a voltage corresponding to the white display or a voltage corresponding to the black display. A data take-in clock CLK is a clock with which the scan driver 28 and the segment driver 29 internally transfer line selection data and image data. A frame start signal FST is a signal to specify the start of data transfer of a display screen to be rewritten and the scan driver 28 and the segment driver 29 reset the interior in accordance with the frame start signal FST. A pulse polarity control signal FR is a polarity-inverted signal of an applied voltage and is inverted at the middle point of time during the stage of write of one line. The scan driver 28 and the segment driver 29 invert the polarity of a signal output in accordance with the pulse polarity control signal FR. A line latch signal LLP is a signal to specify the termination of transfer of line selection data to the scan driver 28 and the scan driver 28 latches line selection data transferred in accordance with the signal. A data latch signal DLP is a signal to specify the termination of transfer of image data to the segment driver 29 and the segment driver 29 latches image data transferred in accordance with the signal. A driver output OFF signal /DSPOF is a forced OFF signal of an applied voltage.

The operation of the segment driver 29 and the signals supplied thereto are the same as those of a general one. The operation of the scan driver 28 is described later.

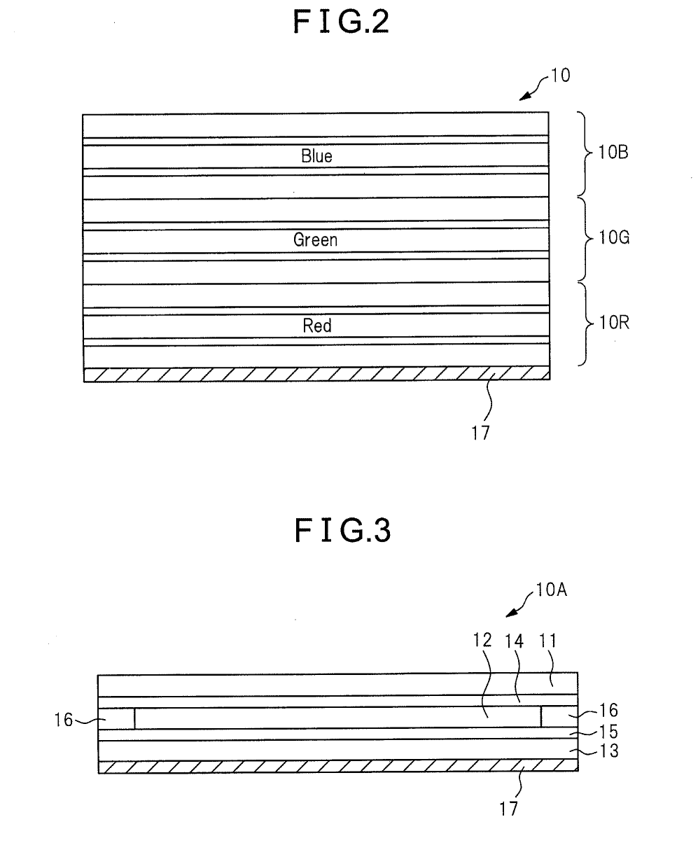

FIG. 2 is a diagram illustrating the configuration of the display element 10 used in the first embodiment. As illustrated in FIG. 2, in the display element 10, three panels, that is, a blue panel 10B, a green panel 10G, and a red panel 10R are laminated in this order from the viewing side and under the red panel 10R, a light absorbing layer 17 is provided. The panels 10B, 10G, and 10R have substantially the same configuration, however, the liquid crystal material and chiral material are selected and the content of the chiral material is determined so that the center wavelength of reflection of the panel 10B is blue (about 480 nm), that of the panel 10G is green (about 550 nm), and that of the panel 10R is red (about 630 nm). The scan electrode and data electrode of the panels 10B, 10G, and 10R are driven by the scan driver 28 and the segment driver 29.

The panels 10B, 10G, and 10R have substantially the same configuration except in that the center wavelengths of reflection differ from one another. Hereinafter, a typical example of the panels 10B, 10G, and 10R is represented by a panel 10A and its configuration is explained.

FIG. 3 is a diagram illustrating a configuration of the panel 10A.

As illustrated in FIG. 3, the display element 10A has an upper side substrate 11, an upper side electrode layer 14 provided on the surface of the upper side substrate 11, a lower side electrode layer 15 provided on the surface of a lower side substrate 13, and a sealing material 16. The upper side substrate 11 and the lower side substrate 13 are arranged so that their electrodes are in opposition to each other and after a liquid crystal material is sealed in between, they are sealed with the sealing material 16. Within a liquid crystal layer 12, a spacer is arranged, however, it is not schematically illustrated. To the electrodes of the upper side electrode layer 14 and the lower side electrode layer 15, a voltage pulse signal is applied and thereby a voltage is applied to the liquid crystal layer 12. A display is produced by applying a voltage to the liquid crystal layer 12 to bring the liquid crystal molecules of the liquid crystal layer 12 into the planar state or the focal conic state. A plurality of scan electrodes and a plurality of data electrodes are formed in the upper side electrode layer 14 and the lower side electrode layer 15.

The upper side substrate 11 and the lower side substrate 13 both have translucency, however, the lower side substrate 13 of the panel 10R does not need to have translucency. Substrates having translucency include a glass substrate, however, in addition to the glass substrate, a film substrate of PET (polyethylene terephthalate) or PC (polycarbonate) may be used.

As the material of the electrode of the upper side electrode layer 14 and the lower side electrode layer 15, a typical one is, for example, indium tin oxide (ITO), however, other transparent conductive films, such as indium zinc oxide (IZO), may be used.

The transparent electrode of the upper side electrode layer 14 is formed on the upper side substrate 11 as a plurality of upper side transparent electrodes in the form of a belt in parallel with one another, and the transparent electrode of the lower side electrode layer 15 is formed on the lower side substrate 13 as a plurality of lower side transparent electrodes in the form of a belt in parallel with one another. Then, the upper side substrate 11 and the lower side substrate 13 are arranged so that the upper side electrode and the lower side electrode intersect each other when viewed in a direction vertical to the substrate and a pixel is formed at the intersection. On the electrode, a thin insulating film is formed. If the thin film is thick, it is necessary to increase the drive voltage. Conversely, if no thin film is provided, a leak current flows, and therefore, there arises such a problem that power consumption is increased. The dielectric constant of the thin film is about 5, which is considerably lower than that of the liquid crystal, and therefore, it is appropriate to set the thickness of the thin film to about 0.3 μm or less.

The thin insulating film may be realized by a thin film of SiO₂ or an organic film of polyimide resin, acryl resin, etc., known as an orientation stabilizing film.

As described above, a spacer is arranged within the liquid crystal layer 12 and the separation between the upper side substrate 11 and the lower side substrate 13, i.e., the thickness of the liquid crystal layer 12 is made constant. The spacer is, for example, a sphere made of resin or inorganic oxide, a fixing spacer obtained by coating a thermoplastic resin on the surface of the substrate, etc. It is preferable for a cell gap formed by the space to be between 4 μm to 6 μm. If the cell gap is less than 4 μm, reflectivity is reduced, resulting in a dark display, and the steepness of high threshold value may not be expected. Conversely, if the cell gap is greater than 6 μm, the steepness of high threshold value may be maintained, however, the drive voltage is increased and it becomes difficult to drive by a general-purpose part.

The liquid crystal composition that forms the liquid crystal layer 12 is cholesteric liquid crystal, which is, for example, nematic liquid crystal mixture to which a chiral material of 10 to 40 weight percent (wt %) is added. The amount of the added chiral material is the value when the total amount of the nematic liquid crystal component and the chiral material is assumed to be 100 wt %.

As the nematic liquid crystal, various liquid crystal materials publicly known conventionally may be used, however, it is desirable to use a liquid crystal material the dielectric constant anisotropy (Δ∈) of which is, for example, in the range of 15 to 35. When the dielectric constant anisotropy is 15 or less, the drive voltage becomes high as a whole and it becomes difficult to use a general-purpose part in the drive circuit. On the other hand, when the dielectric constant anisotropy is 25 or more, the steepness of threshold value is reduced and there grows apprehension about the reduction in reliability of the liquid crystal material itself.

It is desirable for the refractive index anisotropy (Δn) to be 0.18 to 0.24. When the refractive index anisotropy is smaller than this range, the reflectivity in the planar state is reduced and when larger than this range, the scattering reflection in the focal conic state is increased and further, the viscosity is also increased and the response speed is reduced.

Next, the bright and dark (white and black) displays in the display device that uses the cholesteric liquid crystal are explained. The cholesteric liquid crystal display device controls a display by the orientation state of the liquid crystal molecules.

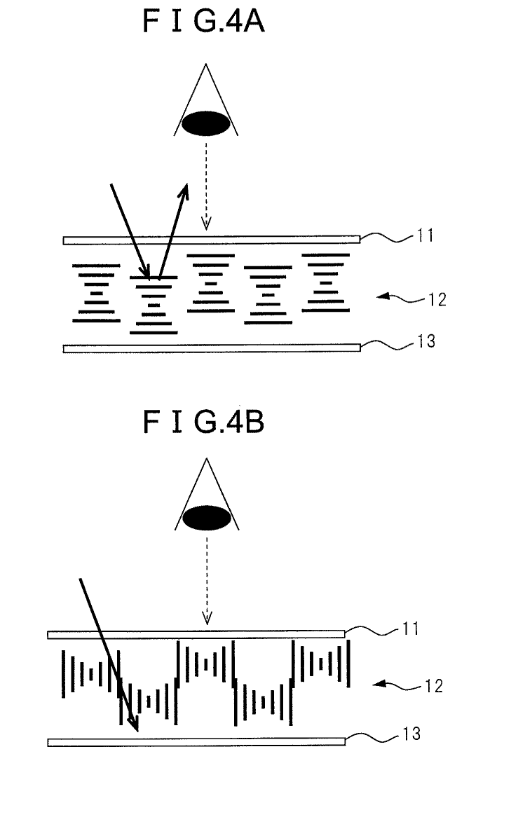

FIGS. 4A and 4B are diagrams explaining the states of the cholesteric liquid crystal. As illustrated in FIGS. 4A and 4B, the display element 10 has the upper side substrate 11, the cholesteric liquid crystal layer 12, and the lower side substrate 13. The cholesteric liquid crystal has the planar state where incident light is reflected as illustrated in FIG. 4A and the focal conic state where incident light is passed as illustrated in FIG. 4B and these states are maintained stably without any electric field. In addition to the above states, there is a homeotropic state where when a strong electric field is applied, all the liquid crystal molecules are oriented in the direction of the electric field and the homeotropic state changes to the planar state or the focal conic state when the application of the electric field is terminated.

In the planar state, light having a wavelength according to the helical pitch of the liquid crystal molecules is reflected. A wavelength λ at which reflection is at its maximum is expressed by the following expression where n is an average refractive index and p is a helical pitch of the liquid crystal.

λ=n·p.

On the other hand, a reflection band Δλ expands as the refractive index anisotropy Δn of liquid crystal increases.

In the planar state, a “bright” state, that is, white may be displayed because incident light is reflected. On the other hand, in the focal conic state, a “dark” state, that is, black may be displayed because light having passed through the liquid crystal layer is absorbed by a light absorbing layer provided under the lower side substrate 13.

Next, a method of driving a display element that utilizes cholesteric liquid crystal is explained.

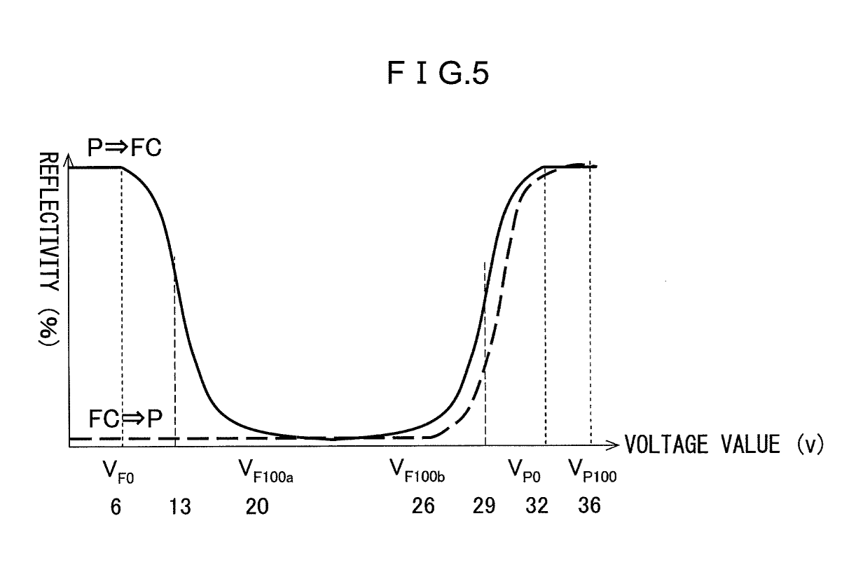

FIG. 5 illustrates an example of voltage-reflection characteristics of general cholesteric liquid crystal. The horizontal axis represents a voltage value (V) of a pulse voltage to be applied with a predetermined pulse width between electrodes that sandwich the cholesteric liquid crystal and the vertical axis represents a reflectivity (%) of the cholesteric liquid crystal. A curve P of a solid line illustrated in FIG. 5 represents the voltage-reflectivity characteristics of the cholesteric liquid crystal the initial state of which is the planar state and a curve FC of a broken line represents the voltage-reflectivity characteristics of the cholesteric liquid crystal the initial state of which is the focal conic state.

When a strong electric field (VP 100 or higher) is caused to occur in the cholesteric liquid crystal, the helical structure of the liquid crystal molecules is undone completely during the stage of application of the electric field and the homeotropic state is brought about, where all of the molecules are oriented in the direction of the electric field. Next, when the liquid crystal molecules are in the homeotropic state, if the applied voltage is reduced rapidly from VP 100 to a predetermined low voltage (for example, VF) to reduce the electric field in the liquid crystal almost to zero, the helical axis of the liquid crystal becomes perpendicular to the electrode and the planar state is brought about, where light in accordance with the helical pitch is reflected selectively.

On the other hand, when a weak electric field with which the helical structure of the liquid crystal molecules is not undone is applied and then the electric field is removed (in a range of VF 100a to VF 100b), or when a strong electric field is applied and then the electric field is removed gradually from the state, the helical axis of the cholesteric liquid crystal molecules becomes parallel with the electrode and the focal conic state where incident light is passed is brought about.

Further, if an electric field of intermediate strength (VF 0 to VF 100a or VF 100b to VF 0) is applied and then the electric field is removed rapidly, the planar state and the focal conic state coexist mixedly and it is made possible to display middle tones.

A display is produced by making use of the above-mentioned phenomena.

As described above, in a display device using cholesteric liquid crystal, the dynamic drive scheme (DDS) is used when performing high-speed rewrite. The display device in the first embodiment produces a two-value image display also by DDS. It may also be possible to perform the reset operation to bring all the pixels into the planar state at the same time before rewriting an image. It is possible to perform the reset operation in a brief stage of time by forcedly setting all the outputs of the scan driver 28 and the segment driver 29 to a predetermined voltage value because transfer of data to set an output value is not necessary. However, the reset operation consumes electric power, and therefore, it may also be possible to not perform the reset operation in a device of low power consumption.

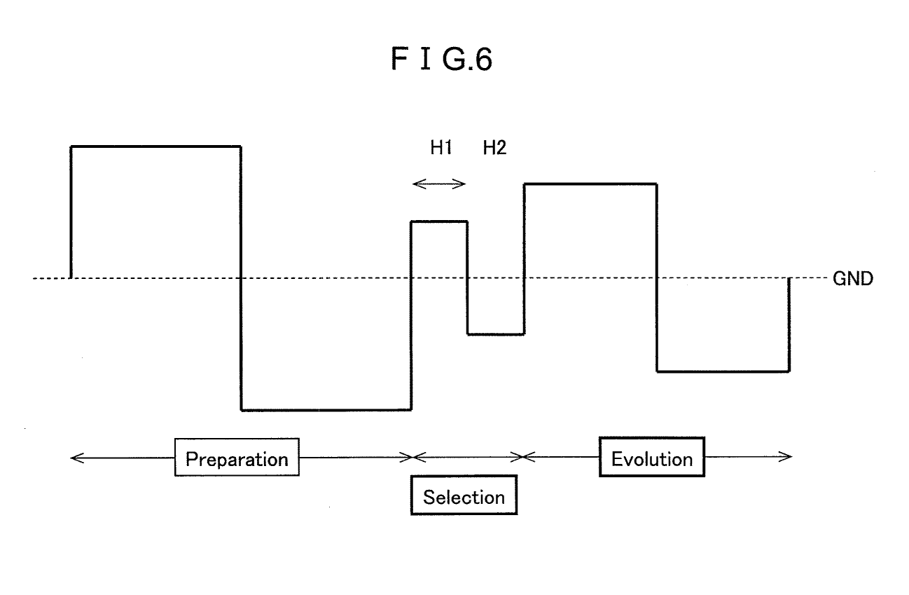

FIG. 6 is a diagram illustrating a drive waveform in DDS.

As described above, DDS is roughly divided into three stages and includes the “preparation” stage, the “selection” stage, and the “evolution” stage in this order from the beginning. Before and after these stages, the non-select stage is provided. The preparation stage is a stage during which liquid crystal is initialized into the homeotropic state and a preparation pulse of a large voltage and a great pulse width is applied. The selection stage is a stage during which branching into the planar state or the focal conic state is triggered and when the state is switched to the planar state, a selection pulse of a low voltage and a small pulse width is applied and when the state is switched to the focal conic state, no pulse is applied. The evolution stage is a stage during which the state is settled to the planar state or the focal conic state according to the transient state during the immediately previous selection stage and an evolution pulse of an intermediate voltage and a great pulse width is applied. The preparation pulse, the selection pulse, and the evolution pulse are a set of positive and negative pulses, respectively.

In actuality, instead of a set of positive and negative of a great pulse width as illustrated in FIG. 6, a plurality of positive and negative preparation pulses and evolution pulses is applied during the preparation stage and the evolution stage.

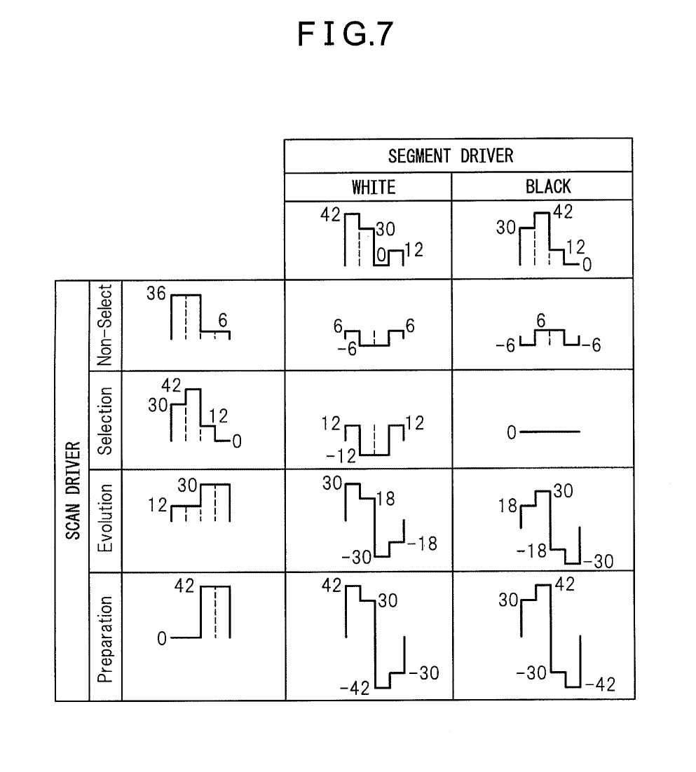

FIG. 7 illustrates drive waveforms the scan driver 28 outputs during the preparation stage, the selection stage, the evolution stage, and the non-select stage, drive waveforms the segment driver 29 outputs for the white display and the black display, and waveforms applied to liquid crystal in the first embodiment.

When performing DDS in the first embodiment, the scan driver 28 outputs six values including GND and the segment driver 29 output four values including GDN in the case of a two-value display.

The scan driver 28 and the segment driver 29 change the output in units of stage that is the selection stage equally divided into four. The segment driver 29 outputs a voltage waveform that changes to 42 V, 30 V, 0 V, and 12 V for the white display and a voltage waveform that changes to 30 V, 42 V, 12 V, and 0 V for the black display. The scan driver 28 outputs a voltage waveform that changes to 36 V, 36 V, 6 V, and 6 V during the non-select stage, a voltage waveform that changes to 30 V, 42 V, 12 V, and 0 V during the selection stage, a voltage waveform that changes to 12 V, 12 V, 30 V, and 30 V during the evolution stage, and a voltage waveform that changes to 0 V, 0 V, 42 V, and 42 V during the preparation stage.

Because of this, during the preparation stage, a voltage waveform that changes to 42 V, 30 V, −42 V, and −30 V is applied to the liquid crystal of the data electrode of the white display and a voltage waveform that changes to 30 V, 42 V, −30 V, and −42 V is applied to the liquid crystal of the data electrode of the black display. During the evolution stage, a voltage waveform that changes to 30 V, 18 V, −30 V, and −18 V is applied to the liquid crystal of the data electrode of the white display and a voltage waveform that changes to 18 V, 30 V, −18 V, and −30 V is applied to the liquid crystal of the data electrode of the black display. During the selection stage, a voltage waveform that changes to 12 V, −12 V, −12 V, and 12 V is applied to the liquid crystal of the data electrode of the white display and a voltage waveform of 0 V is applied to the liquid crystal of the data electrode of the black display. During the non-select stage, a voltage waveform that changes to 6 V, −6 V, −6 V, and 6 V is applied to the liquid crystal of the data electrode of the white display and a voltage waveform that changes to −6 V, 6 V, 6 V, and −6 V is applied to the liquid crystal of the data electrode of the black display.

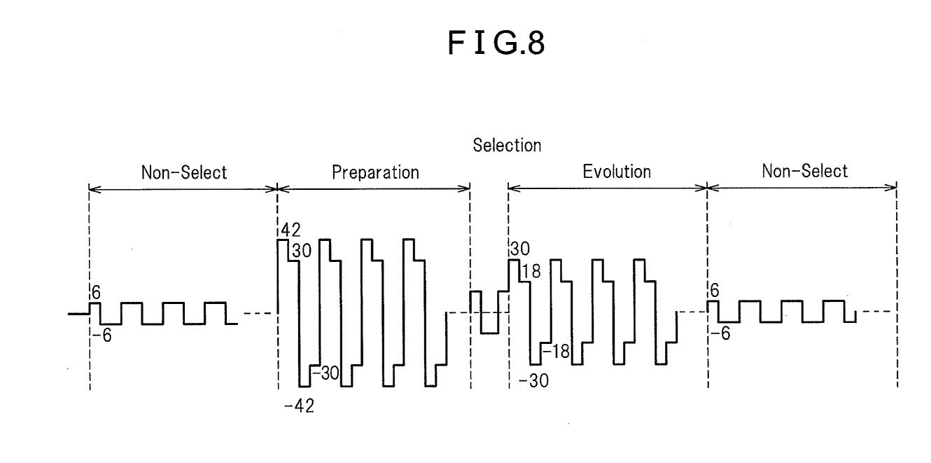

FIG. 8 is a diagram more specifically illustrating a voltage waveform applied to the liquid crystal molecules by the scan driver 28 and the segment driver 29 outputting the drive waveforms illustrated in FIG. 7. The voltage waveform in FIG. 8 is applied to one scan line.

As illustrated in FIG. 8, the preparation stage, the selection stage, and the evolution stage are arranged in this order and the non-select stage is arranged before and after them. The selection stage has an application time of about 0.5 ms to 1 ms. FIG. 8 illustrates a selection pulse of ±12 V when producing a white display (bright display) in the planar state and 0 V is applied during this stage when producing a black display (dark display) in the focal conic state.

The preparation stage and the evolution stage have a length several to ten-something times that of the selection stage and a plurality of the preparation pulses and the evolution pulses in FIG. 7 is applied. During the non-select stage, a pulse applied at all times to a pixel that is not involved in drawing has a low voltage, and therefore, it does not change the image.

A set of the preparation pulse, the selection pulse, and the evolution pulse in FIG. 8 is applied sequentially while changing the position of the scan line. Due to this, the selection pulse performs san/rewrite in a pipeline manner in the application time of the selection pulse for each line together with the preparation pulse and the evolution pulse. Because of this, it is possible to perform rewrite at a speed of about 1 ms×768=0.77 m even in a display element of the high precision size of the XGA specifications.

In the conventional example, a general-purpose STN driver is used in the scan (common) mode and the applied waveform in FIG. 8 is applied while shifting the scan line one by one. Because of this, the several to ten-something preparation pulses and evolution pulses are applied to the neighboring scan line successively as a result and a black belt appears. Even when a set of the preparation pulse, the selection pulse, and the evolution pulse is applied to every two scan lines in an interlacing manner, the preparation pulse and the evolution pulse are applied successively to every two scan lines. Because of this, the black belt becomes paler, however, a long black belt appears.

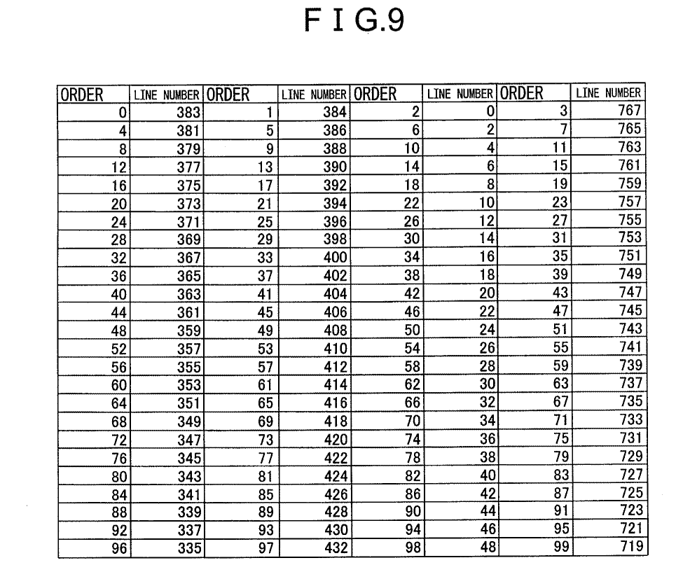

FIG. 9 is a diagram illustrating a scan order in the display device in the first embodiment. As described above, the scan line corresponding to the scan electrode at the uppermost part of the screen is assumed to be the 0th line and the scan line corresponding to the scan electrode at the lowermost part of the screen is assumed to be the 767th line and FIG. 9 illustrates the 0th to 99th scan lines in the scan order.

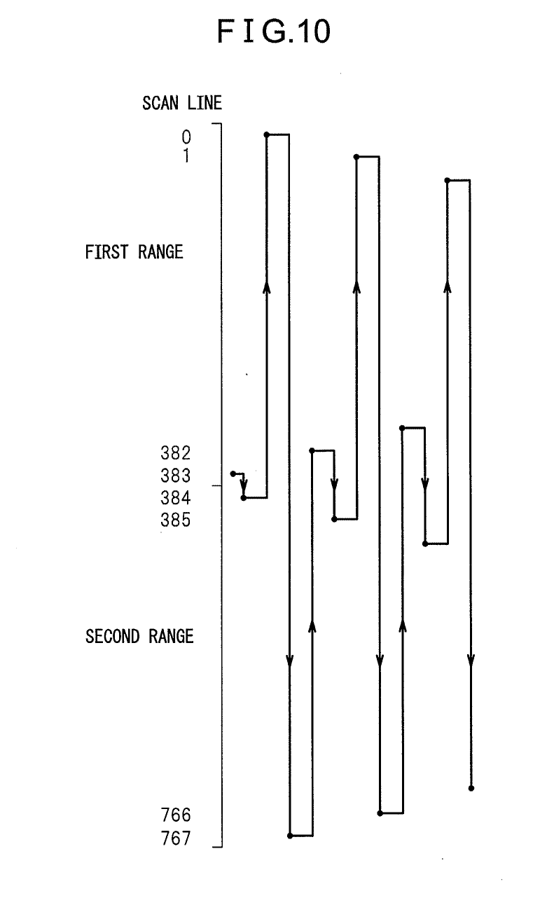

FIG. 10 is a diagram for schematically explaining the scan order illustrated in FIG. 9. It is assumed that the scan electrode (line) extends in the transverse direction and the screen is divided into the upper part and the lower part and the upper part is referred to as a first region and the lower part as a second region. The scan line changes in order from the 383rd line at the lowermost part in the first region to the 384th line at the uppermost part in the second region, the 0th line at the uppermost part in the first region, the 767th line at the lowermost part in the second region, the 382nd line at the second part from the lowermost part in the first region, the 385th line at the second part from the uppermost part in the second region, the first line at the second part from the uppermost part in the first region, the 767th line at the second part from the lowermost part in the second region, and so on.

In order to perform write in the scan order illustrated in FIG. 9 and FIG. 10, the scan driver 28 in the first embodiment is realized by using a general-purpose STN driver capable of outputting outputs of six or more values in the segment mode.

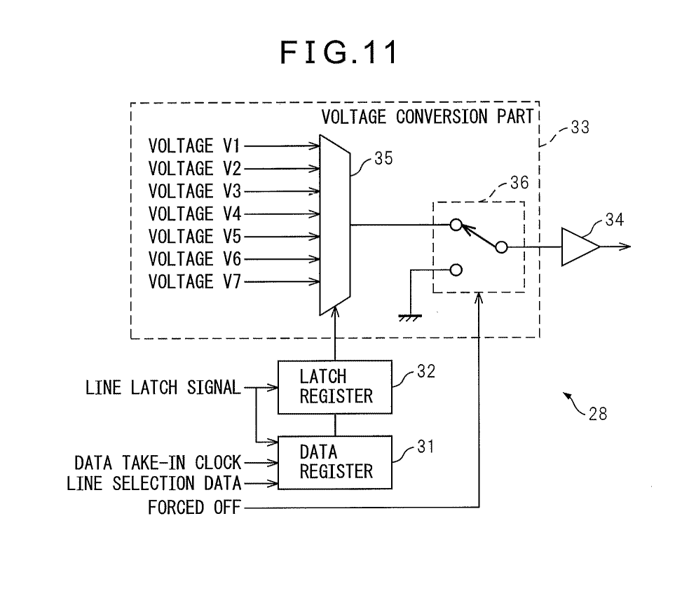

FIG. 11 is a diagram illustrating a configuration of the scan driver 28. As illustrated in FIG. 11, the scan driver 28 comprises a data register 31, a latch register 32, a voltage conversion part 33, and an output buffer 34. The voltage conversion part 33 and the output buffer 34 are provided in the number corresponding to the number of outputs. The data register 31 is a shift register that shifts the line selection data to be input by one bit each time according to the data take-in clock CLK. When completing the transfer of the line selection data corresponding to one screen, the latch register 32 latches the output of the data register 31 according to the line latch signal LLP and maintains the state until the next line latch signal LLP is input. The voltage conversion part 33 has an analog multiplexer 35 that selects one voltage from among seven voltages V1 to V7 according to the value output from the latch register 32 and a switch 36 that selects one of the outputs of the analog multiplexer 35 according to the forced OFF signal. The output of the switch 36 is input to the output buffer 34. In FIG. 11, an example is illustrated, in which the analog multiplexer 35 selects one voltage from among the seven voltages V1 to V7, however, what is required is only that one voltage may be selected from among the six voltages.

The segment driver 29 has the configuration similar to that of the scan driver 28 illustrated in FIG. 11, however, is only required to be capable of outputting four values including GND as illustrated in FIG. 7.

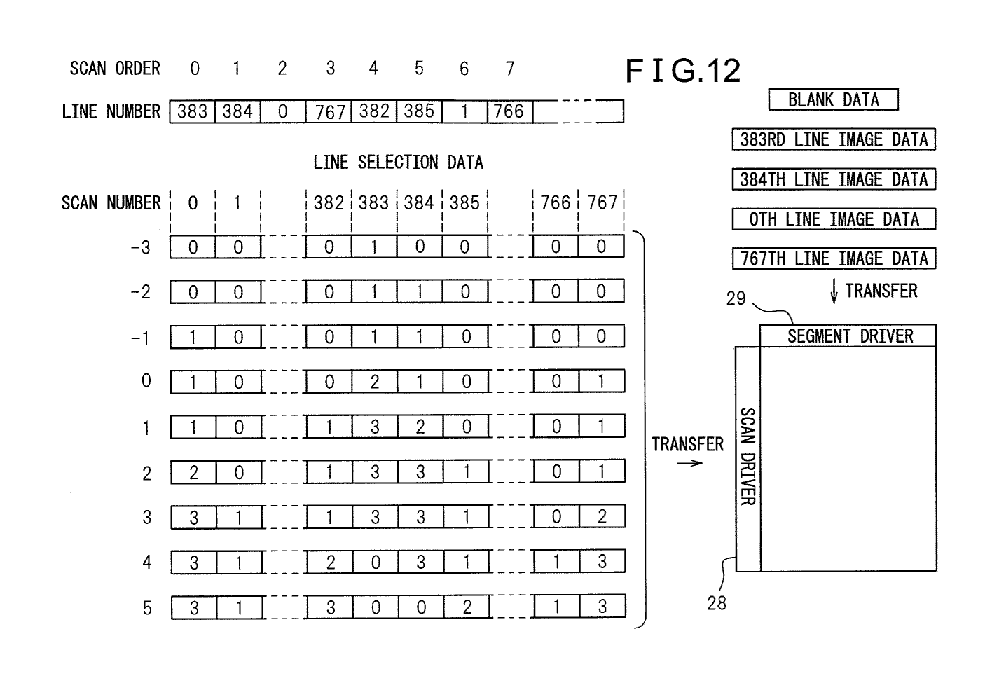

FIG. 12 is a diagram explaining the operation of the scan driver 28, also illustrating the scan order and the change of the line selection data. Here, “0” of the line selection data indicates non-select, “1” indicates selection, “2” indicates preparation, and “3” indicates evolution. Consequently, a line selection data LLS is required only to have 2 bits or more. In order to simplify explanation, a case is explained where the preparation pulse and the evolution pulse are applied three times, respectively, before and after the selection pulse.

The scan order is the 383rd line, the 384th line, the 0th line, the 767th line, the 382nd line, the 385th line, the first line, the 766th line, and so on. When the selection pulse is applied to the 383rd line in the scan order 0 is referred to as scan number “0” and the scan number increases sequentially and before the scan number 0, scan numbers −3 to −1 are provided in order to apply the preparation pulse three times. Although not illustrated schematically, after scan number 767, scan numbers 768 to 770 are provided in order to apply the evolution pulse three times.

At the scan number −3, line selection data to set 1 to the 383rd line and 0 to the other lines is transferred to the scan driver 28 and the scan driver 28 applies the preparation pulse to the scan electrode of the 383rd line and the non-selection pulse to the other scan electrodes.

At the scan number −2, line selection data to set 1 to the 383rd line and 384th line and 0 to the other lines is transferred to the scan driver 28 and the scan driver 28 applies the preparation pulse to the scan electrode of the 383rd line and 384th line and the non-pulse to the other scan electrodes.

At the scan number −1, line selection data to set 1 to the 383rd line, 384th line, and 0th line and 0 to the other lines is transferred to the scan driver 28 and the scan driver 28 applies the preparation pulse to the scan electrode of the 383rd line, 384th line, and 0th line and the non-select pulse to the other scan electrodes.

At the scan number 0, line selection data to set 2 to the 383rd line, 1 to the 384th line, 0th line, and 767th line, and 0 to the other lines is transferred to the scan driver 28 and the scan driver 28 applies the selection pulse to the scan electrode of the 383rd line, the preparation pulse to the scan electrode of the 384th line, 0th line, and 767th line. and the non-select pulse to the other scan electrodes.

At the scan number 1, line selection data to set 3 to the 383rd line, 2 to the 384th line, 1 to the 0th line, 767th line, and 382nd line, and 0 to the other lines is transferred to the scan driver 28 and the scan driver 28 applies the evolution pulse to the scan electrode of the 383rd line, the selection pulse to the scan electrode of the 384th line, the preparation pulse to the scan electrode of the 0th line, 767th line, and 383rd line, and the non-select pulse to the other scan electrodes.

After this, the scan lines to which the preparation pulse, the selection pulse, and the evolution pulse are applied are changed similarly and after the evolution pulse is applied to a scan line three times, the non-select pulse is applied to the scan line.

In synchronization with the transfer of line selection data to the scan driver 28, image data is transferred and output to the segment driver 29. The image data of the line to which the selection pulse is applied is transferred in such a manner that blank data that does not change the image is transferred at the scan numbers −3 to −1, the image data of the 383rd line at the scan number 0, the image data of the 384th line at the scan number 1, the image data of the 0th line at the scan number 2, the image data of the 767th line at the scan number 3, and so on. The segment driver 29 outputs the drive voltages corresponding to the white display and the black display of the image data.

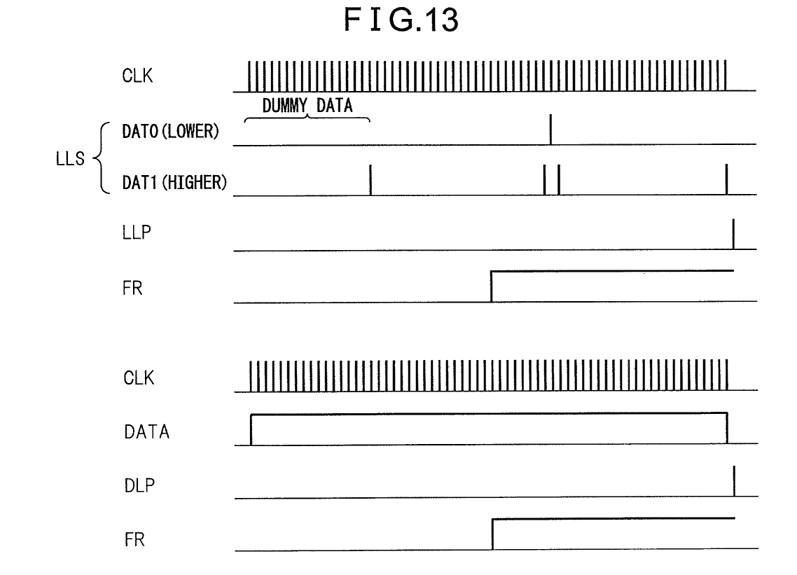

FIG. 13 is a time chart illustrating the transfer of line selection data to the scan driver 28 and the transfer of image data to the segment driver 29 at the scan number 0. The line selection data LLS is configured by 2 bits, that is, a lower bit DAT0 and a higher bit DAT1 and “00” indicates non-select, “01” selection, “10” preparation, and “11” evolution. The data transfer to the scan driver 28 and the segment driver 29 is performed by the common data take-in clock CLK, and therefore, as the line selection data corresponding to the first 256 clocks, dummy data is transferred. As illustrated in FIG. 13, at the timing corresponding to the 383rd line, DAT0 turns to “1” and at the timing corresponding to the 384th line, 0th line, 767th line, and 385th line, DAT1 turns to “1”. The line selection data and image data transferred are latched in synchronization with the line latch signal LLP and the data latch signal DLP. The pulse polarization control signal FR changes in the middle position of the selection stage of one scan line.

In the display device in the first embodiment, write is performed in the scan order illustrated in FIG. 9 and FIG. 10, and therefore, the scan lines to which the preparation pulse and the evolution pulse are applied are dispersed and the scan lines are unlikely to be conspicuous as a belt. Further, the image is drawn from the center in the two upward and downward directions, from the top end in the downward direction, and from the bottom end in the upward direction, and therefore, the image seems to float up from the four positions.

In the first embodiment, the positions of scan lines are dispersed, and therefore, there may be a case where variations in display occur depending on the response characteristics of the panel. It is known that the variations in display depend on the application time of the non-select voltage applied before and after the write of an image. For example, the line drawn earlier has a long application time of the non-select voltage after that and its contrast is relatively high and on the other hand, the line written later has a short application time of the non-selection voltage after that and its contrast is relatively low. Because of this, it is possible to correct the contrast by continuing the application of the non-select pulse for a while after the screen is written.

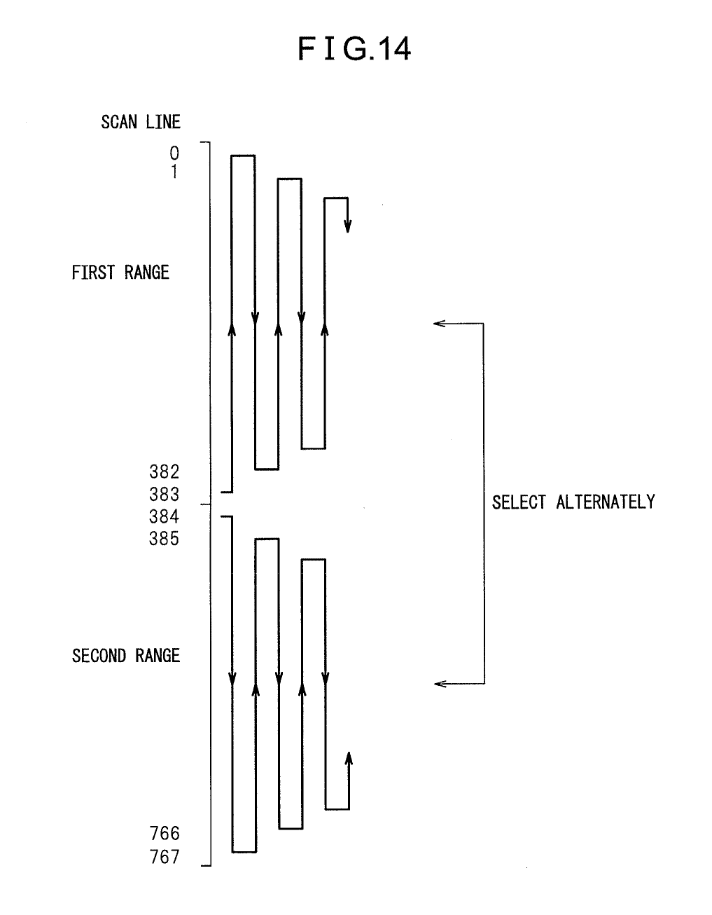

FIG. 14 is a diagram explaining the change in scan position (scan order) in the first embodiment from another viewpoint. As illustrated in FIG. 14, the screen is divided into the upper part and the lower part and the upper part is referred to as the first region and the lower part as the second region. In the first region, the scan positions are selected so that the positions change alternately from the 383rd line and the 0th line on both ends toward the inside of the first region and in the second region also, the scan positions are selected so that the positions change alternately from the 384th line and the 767th line on both ends toward the inside of the second region and further, the first region and the second region are selected alternately. Due to this, the scan order illustrated in FIG. 10 is realized.

In order to prevent the scan lines to which the preparation pulse and the evolution pulse are applied from becoming conspicuous as a belt and to cause the image to be rewritten to appear as if it floats up, the scan order is dispersed. As to how to disperse, there may be various modified examples. The modified examples of the scan order are explained below.

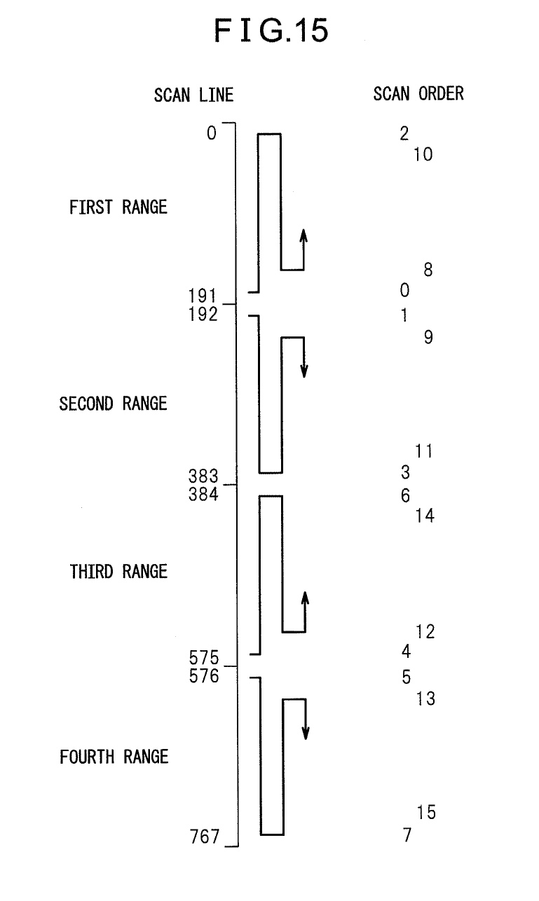

FIG. 15 is a diagram explaining a modified example of the scan order. In this modified example, it is assumed that the screen is divided into first to fourth regions in order from the upper side and the scan positions are selected so that in the first region, the positions change alternately from the 191st line and the 0th line on both ends in the direction toward the inside of the first region, in the second region also, the positions change alternately from the 192nd and the 383rd line on both ends in the direction toward the inside of the second region, in the third region, the positions change alternately from the 575th line and the 384th line on both ends in the direction toward the inside of the third region, and in the fourth region also, the positions change alternately from the 576th line and the 767th line on both ends in the direction toward the inside of the fourth region. After this, the first region and the second region are selected alternately four times, the third region and the fourth region are selected alternately four times, and this is repeated. As a result, the scan order is the 191st line, the 192nd line, the 0th line, the 383rd line, the 575th line, the 576th line, the 384th line, and the 767th line as illustrated schematically.

In FIG. 15, instead of alternately selecting the first region and the second region four times and then alternately selecting the third region and the fourth region four times, it may also be possible to repeat the selection of the first region, the third region, the second region, and the fourth region. In the modified example in FIG. 15, the belt is more inconspicuous compared to the case in the first embodiment.

For the scan order, there can also be various modified examples other than that in FIG. 15. For example, the scan positions may be selected so that the positions change from the center toward both ends in each region and the number of divisions of the screen or the selection order of the regions is not limited.

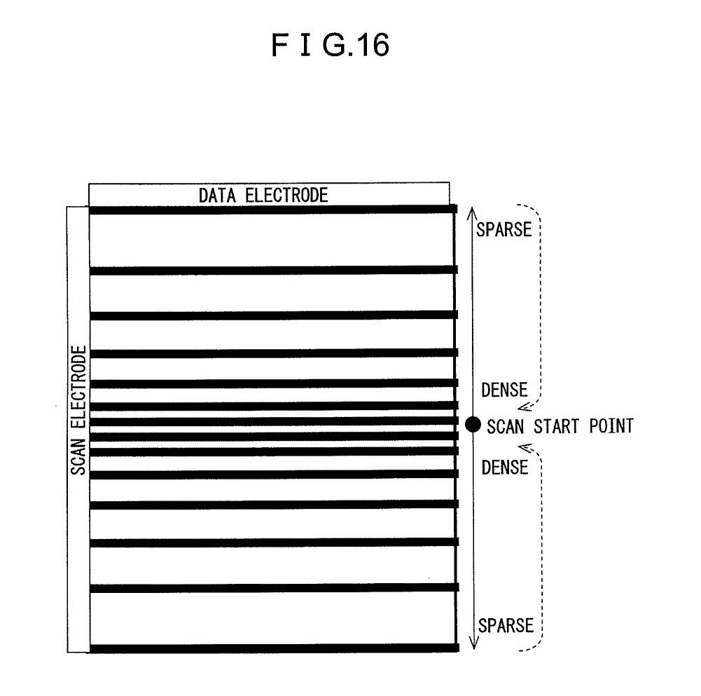

FIG. 16 is a diagram illustrating another modified example of the scan order.

In the scan order in FIG. 16, the center of the screen is the start point of rewrite and rewrite is performed alternately in the upward and downward directions therefrom, however, the intervals of the scan order are controlled so as to be small at the screen center and to increase toward both ends of the screen. Then, write is performed in order from scan lines not written near the center. In this case, naturally the black belt seems to be dispersed and the image seems to float up gradually from the screen center.

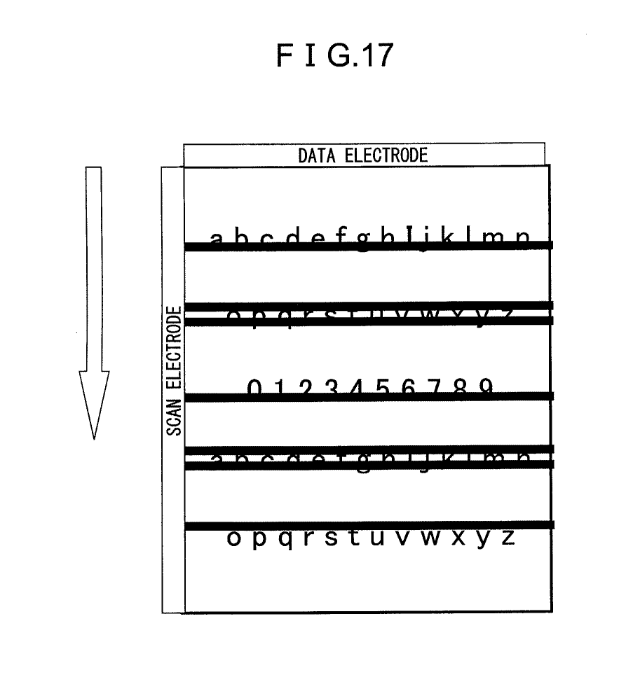

FIG. 17 is a diagram illustrating still another modified example of the scan order.

In the scan order in FIG. 17, rewrite is performed in order of most important line of the image to be rewritten first. The line corresponding to a letter is more important when performing write in, for example, an image including letters. In a general image, rewrite is performed in order of line having a more amount of information. As the definition of the amount of information, for example, the variations in the pixel value in the horizontal direction may be thought and the more the variations in the pixel value, the more amount the information is deemed to have, however, another definition may be used as the amount of information. In this case, when the variations in the pixel value are small, the amount of information may be deemed to be small. In the case of a display content in which letters are predominant, such as a newspaper, a line in which letters are simply written is extracted and the scan order in the first embodiment or the modified examples may be applied within the extracted line.

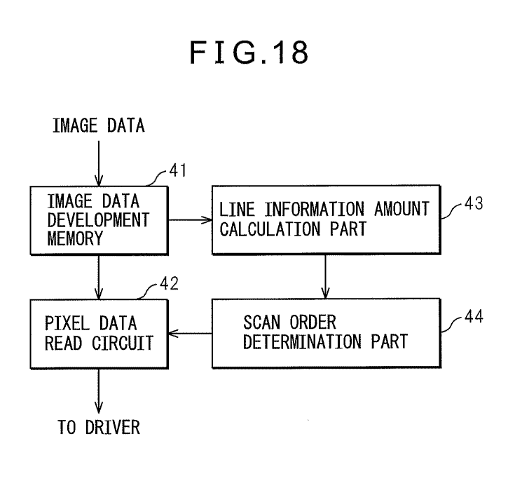

FIG. 18 is a diagram illustrating a configuration of the control circuit 27 when the scan order in FIG. 17 is determined. The control circuit 27 has a bit-map image data development memory 41, an image data read circuit 42 that reads image data from the image data development memory 41 when writing an image, a line information amount calculation part 43, and a scan order determination part 44. The line information amount calculation part 43 calculates the pixel variation value for each scan line by accessing the image data development memory 41 and regards it as an amount of line information. The scan order determination part 44 determines a scan order based on the amount of line information calculated by the line information amount calculation part 43 and controls the read order in the image data read circuit 42.

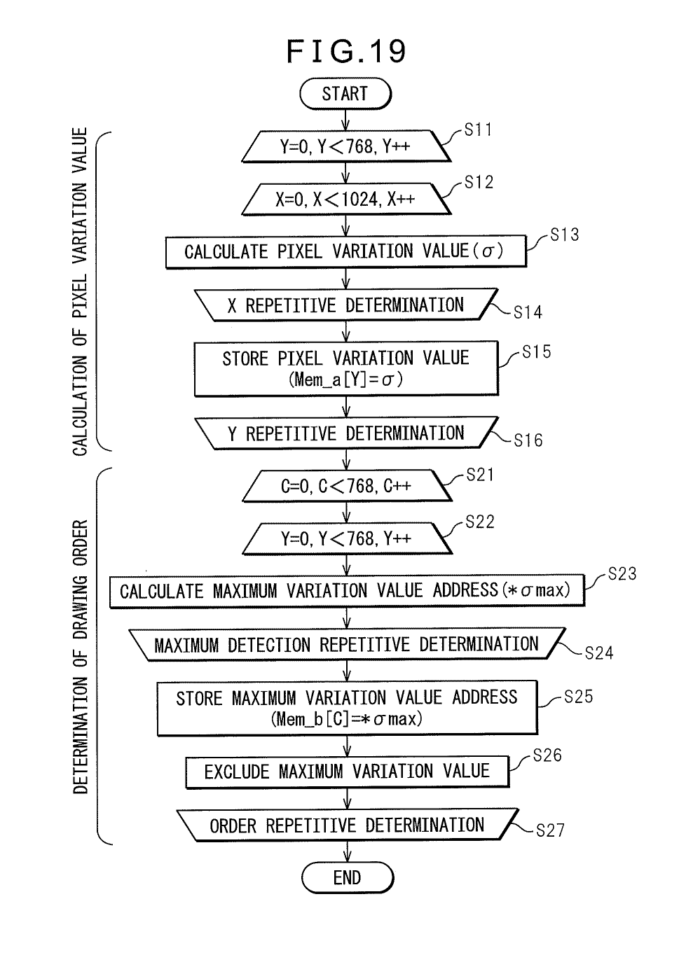

FIG. 19 is a flowchart illustrating processing in the line information amount calculation part 43 and the scan order determination part 44.

S11 to S16 are processing to calculate a pixel variation value a for each scan line and S21 to S27 are processing to determine a scan order.

In S11, a scan position (position in the longitudinal direction) Y is set to a range from 0 to 767 and Y is increased by one each time in the repetitive calculation.

In S12, a pixel position (position in the transverse direction) X is set to a range from 0 to 1,023 and X is increased by one each time in the repetitive calculation.

In S13, a difference of the pixel value between a pixel in the pixel position X on the line in the scan position Y and its neighboring pixel is calculated as the pixel variation value σ.

In S14, whether the calculation of the pixel variation value σ on the line in the scan position Y is completed is determined and if not completed, the processing returns to S12. By repeating S12 to S14, the calculation of the pixel variation value σ of all the pixels on the line in the scan position Y is performed.

In S15, the sum of the pixel variation values σ of all the pixels on the line in the scan position Y is calculated and stored in a list associated with Y.

In S16, whether the calculation of the sum value of the pixel variation values σ on all the scan lines is completed is determined and if not completed, the processing returns to S11. By repeating S11 to S16, the calculation of the sum value of the pixel variation values σ on all the scan lines is performed and stored in the list.

In S21, a variable C indicative of the scan order is set to a range from 0 to 767 and C is increased by one each time in the repetitive calculation.

In S22, the scan position Y is set to a range from 0 to 767 and Y is increased by one each time in the repetitive calculation.

In S23, the pixel variation value σ in the scan position Y is read from the list and whether it is greater than the pixel variation value σ in the previous scan position Y−1 is determined and if greater, the scan position is calculated as an address σmax.

In S24, whether the comparison with the pixel variation value in the previous scan position is completed on all the scan lines is determined and if not completed, the processing returns to S22. By repeating S22 to S24, the scan line on which the pixel variation value becomes the maximum on all the scan lines is calculated.

In S25, the scan line calculated in S24 on which the pixel variation value becomes the maximum is stored as the scan order C.

In S26, the scan line stored in S25 on which the pixel variation value becomes the maximum is excluded from the list that stores the pixel variation values on all the scan lines.

In S27, whether the scan order C is determined to the last is determined and if not determined, the processing returns to S21. As described above, the scan line with the maximum variation value is excluded in S26, and therefore, by repeating S11 to S16, all the scan orders C are determined.

In order to make inconspicuous the scan line to which the preparation pulse and the evolution pulse are applied, it is also possible to determine the scan order randomly. It may also be possible to store a random scan order in the memory in advance as a random fixed pattern or to determine a scan order based on a random number that is created based on time information etc. Because the scan order is random, such write by which an image seems to float up may be achieved to a certain degree, however, because of the randomness, there may occur a case where the degree of visual satisfaction is degraded somewhat compared to the scan order in the first embodiment and modified examples.

Because of this, it is desirable for the scan order to have some regularity that may be defined or to be determined according to image information as illustrated in FIG. 17. Further, the scan order does not need to be fixed.

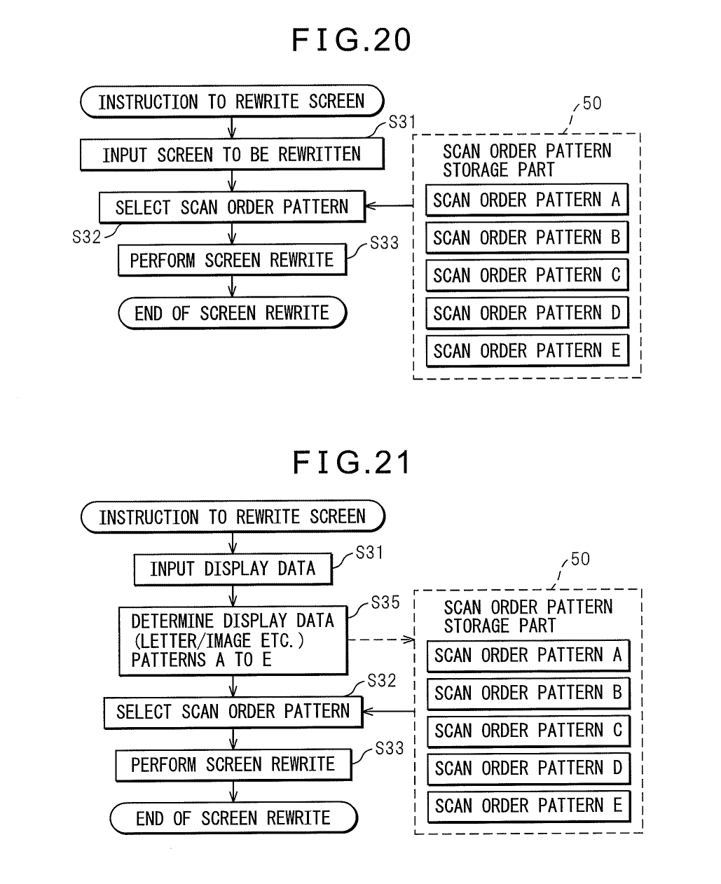

FIG. 20 is a diagram illustrating a configuration of a modified example in which the scan order may be changed. The control circuit 27 has a scan order pattern storage part 50 and stores a plurality of scan orders A, B, C, D, and E and when rewriting a display, it determines which scan order is used in rewrite appropriately and performs rewrite according to the scan order determined. The scan orders A, B, C, D, and E may be any scan order pattern with which a black belt is not conspicuous, such as a pattern illustrated in FIG. 9 and FIG. 10 and a pattern illustrated in FIG. 15 and FIG. 16. It may also be possible to select a scan order pattern randomly or according to a certain rule.

When an instruction to rewrite a screen is received, data to rewrite the screen is input in S31, a scan order pattern is selected in S32, and the screen is rewritten according to the scan order pattern selected in S33 and the processing ends.

Further, as illustrated in FIG. 21, it may also be possible to determine whether the image is an image including letters or graphic image based on the display data after S31 and to further provide S35 in which any of the scan order patterns A to E is selected according to the determination result. Information about the pattern selected in S35 is notified to the scan order pattern storage part 50 and the scan order pattern storage part 50 outputs the selected pattern. Due to this, rewrite may be performed in the scan order suitable for the image to be rewritten.

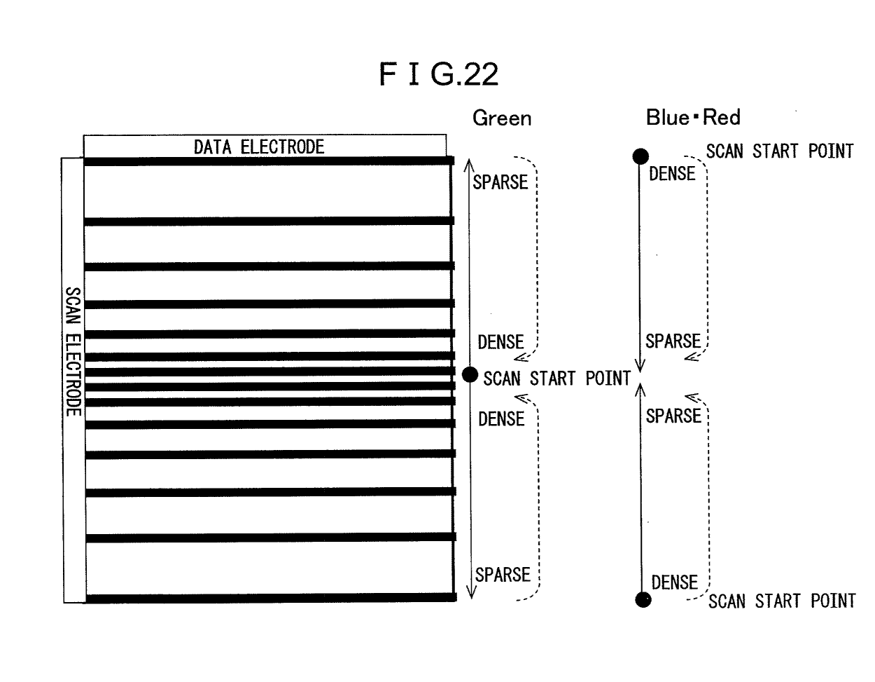

Next, a display device in a second embodiment is explained with reference to FIG. 22.

### Second Embodiment

As illustrated in FIG. 1, in the first embodiment, the color display element 10 in which the three panels 10B, 10G, and 10R are laminated is used and the scan driver 28 commonly drives the scan electrodes of the three panels 10B, 10G, and 10R. Because of this, the image in the three panels 10B, 10G, and 10R is rewritten in the same scan order. However, it is not necessary to rewrite the image in the three panels 10B, 10G, and 10R in the same scan order.

In the display device in the second embodiment, the scan order of the green panel 10G is different from the scan order of the blue panel 10B and the red panel 10R. In order to enable such an operation, the three scan drivers 28 are provided for the three panels 10B, 10G, and 10R to make it possible to drive the scan electrodes of the three panels 10B, 10G, and 10R independently. Other parts are substantially the same as those in the first embodiment.

FIG. 22 is a diagram illustrating the scan order in the display device in the second embodiment.

As illustrated in FIG. 22, the scan order of the green panel 10G starts from the screen center illustrated in FIG. 16 as a rewrite start point and from this point, rewrite is performed alternately in the upward and downward directions, however, the intervals of the scan order are made small at the screen center and the intervals are increased as the rewrite advances toward both ends of the screen. The scan order of the blue panel 10B and the red panel 10R starts from both ends of the screen as a rewrite start point and from these points, rewrite is performed alternately in the direction toward the center, however, the intervals of the scan order are made small at both ends of the screen and the intervals are increased as the rewrite advances toward the screen center.

As to which scan order is used to rewrite each color panel, there may be various modified examples. For example, it may also be possible to apply the scan order of the green panel 10G to the blue panel 10B or the red panel 10R and the scan order of the blue panel 10B or the red panel 10R to the green panel 10G in FIG. 22.

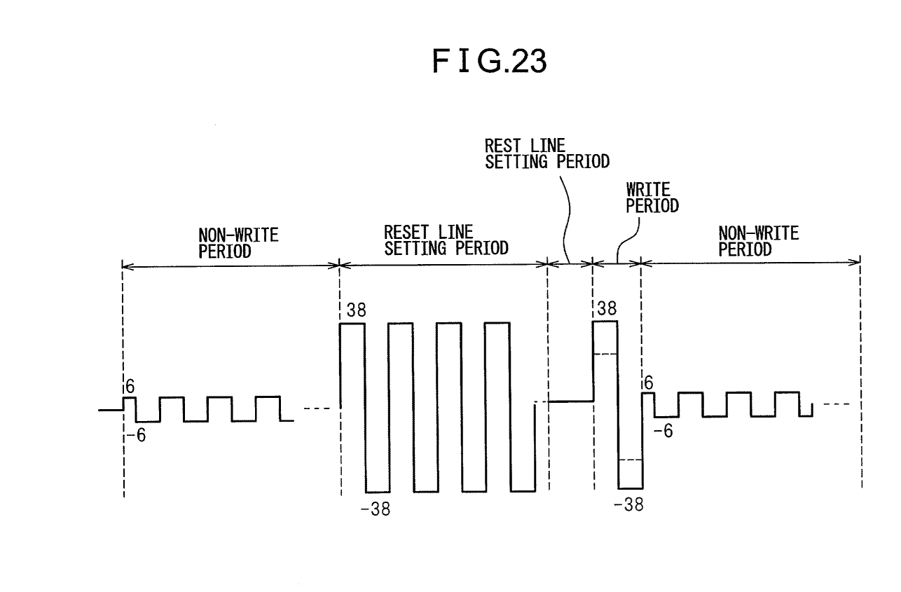

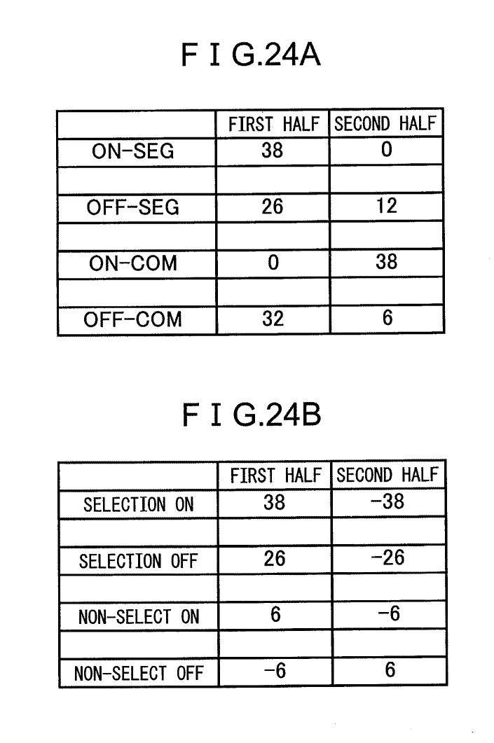

Next, a display device in a third embodiment is explained with reference to FIG. 23 and FIGS. 24A and 24B.

### Third Embodiment

In the first embodiment, its modified examples, and the second embodiment, the dynamic drive scheme (DDS) is used, however, by any drive system that uses an auxiliary pulse, it is possible to make inconspicuous a belt resulting from the auxiliary pulse by dispersing scan lines to which the auxiliary pulse is applied. In the display device in the third embodiment, a display is rewritten using the pseudo reset method described in Patent Document 7 as an example of the conventional drive, different from DDS.

FIG. 23 is a diagram illustrating a voltage waveform to be applied to liquid crystal molecules of one scan line in the display device in the third embodiment. As illustrated schematically, the drive waveform in the pseudo reset method has a reset line setting stage, a rest line setting stage, and a write stage and a non-write stage is provided before and after them, respectively.

The reset line setting stage resembles the preparation stage of DDS and a plurality of reset pulses resembling the preparation pulse is applied. The reset pulse is a pulse of ±38 V. During the rest line setting stage, 0 V is applied. During the write stage, one pulse of ±38 V is applied in the case of the white display and one write pulse of ±26 V is applied in the case of the black display. By the application of the reset pulse, the liquid crystal in the pixel is initialized into the planar state or the focal conic state and the planar state or the focal conic state is settled by the write pulse. The reset pulse forms a black belt of about 20 pulses.

As obvious from the comparison with FIG. 8, in the pseudo reset method, as in DDS, a series of pulse string is applied to each scan line and it is possible to perform write by setting a scan order with a configuration similar to that explained in the first embodiment.

The pseudo reset method has a comparatively low speed, however, power consumed at the time of write is small and it is also possible to perform write by supplying power wirelessly without a battery. Further, the pseudo reset method dose not require outputs of so many values as required by DDS and it is possible to use an inexpensive general-purpose driver IC of two-value output.

FIGS. 24A and 24B are diagrams illustrating outputs of a scan driver and a segment driver configured by a general-purpose driver IC of two-value output and voltages applied to each pixel when performing the pseudo reset method.

As illustrated in FIG. 24A, the segment driver outputs 38 V in the first half and 0 V in the second half for the pixel of the white display (ON-SEG) and outputs 26 V in the first half and 12 V in the second half for the pixel of the black display (OFF-SEG). The scan driver outputs 0 V in the first half and 38 V in the second half for the selected line (line to which the reset pulse and the write pulse are applied: ON-COM) and outputs 32 V in the first half and 6 V in the second half for the non-selected line (OFF-COM).

Consequently, as illustrated in FIG. 24B, to the pixel of the data electrode of the white display on the selected line, 38 V is applied in the first half and −38 V in the second half and to the pixel of the data electrode of the black display on the selected line, 26 V is applied in the first half and −26 V in the second half. Further, to the pixel of the data electrode of the white display on the non-selected line, 6 V is applied in the first half and −6 V in the second half and to the pixel of the data electrode of the black display on the non-selected line, −6 V is applied in the first half and 6 V in the second half.

According to the embodiments, in the scan in which the display is rewritten, the positions of the plurality of scan electrodes to which the rewrite pulse is applied change at irregular intervals. Due to this, the image to be rewritten appears to be dispersed in a wide region, and therefore, the black belt by the auxiliary pulse is dispersed and becomes inconspicuous and at the same time, it appears in such a manner that the display surfaces and it is made possible to quickly recognize the entire image.

In the embodiments explained above, the example is explained, in which the color display element in which the three panels are laminated is used, however, it is also possible to apply the configurations in the first to third embodiments to a monochrome display element with one panel.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a display part;
an electrode that applies a pulse to a pixel of the display part; and
a control part that controls the application of the pulse, wherein
the control part controls the position of the electrode that applies the pulse so as to change at irregular intervals.

2. The display device according to claim 1, wherein
the display surface of the display part is defined into a plurality of regions, and
the control part selects the position of the electrode that applies the rewrite pulse by selecting electrodes in different regions sequentially and selecting the position alternately from both ends toward the center or from the center toward both ends in each of the regions.

3. The display device according to claim 1, wherein
the control part selects the position of the electrode that applies the pulse alternately from the center toward both ends and densely at the center and sparsely at both ends, or alternately from both ends toward the center and densely at both ends and sparsely at the center and thus selects all the electrodes.

4. The display device according to claim 1, further comprising a line information amount calculation part that calculates an amount of information for each scan line corresponding to the electrode, wherein
the control part selects the position of the electrode that applies the pulse based on the amount of information.

5. The display device according to claim 1, further comprising a scan pattern storage part that stores patterns of changes in the position of the electrode that applies the pulse, wherein
the control part changes the electrode that applies the pulse according to the pattern selected from among the patterns stored in the storage part.

6. The display device according to claim 5, wherein
to the electrode, a plurality of preparation pulses, one selection pulse, and a plurality of evolution pulses are applied.

7. The display device according to claim 5, wherein
to the electrode, a plurality of reset pulses, one rest pulse, and one write pulse are applied.

8. A display device comprising a plurality of laminated display elements, wherein
the display element comprises:
a display part;
an electrode that applies a pulse to a pixel of the display part; and
a control part that controls the application of the pulse, and
the control part controls the position of the electrode that applies the pulse so as to change at irregular intervals and at the same time, controlling the changes in the position of the plurality of scan electrodes that apply the pulse differ at least between two of the plurality of display elements.
